(19) United States
(12) Patent Application Publication
(10) Pub. No.: US 2016/0337755 A1
(43) Pub. Date: Nov. 17, 2016

(54) SURROUND SPEAKER

(71) Applicant: Paradigm Electronics Inc., Mississauga (CA)

(72) Inventors: Scott Bagby, Mississauga (CA); Oleg Bogdanov, Toronto (CA)

(21) Appl. No.: 14/986,862

(22) Filed: Jan. 4, 2016

Related U.S. Application Data
(60) Provisional application No. 62/160,929, filed on May 13, 2015.

(51) Int. Cl. H04R 5/04; H04R 1/32; H04R 1/26

(52) U.S. Cl. CPC H04R 5/04; H04R 1/26; H04R 1/323

(57) ABSTRACT

The present invention provides a surround sound loudspeaker system and a surround sound speaker system housing. The system comprises a first loudspeaker, a second loudspeaker. The first speaker and the second speaker are switchable between a first mode and a second mode. The surround sound speaker system housing comprises first and second cabinets on first and second sides of the housing respectively. Each of the first and second cabinets comprises a front plane, a side plane, and a rear plane. The side planes of the first and second cabinets are in an angled position, and wherein the rear planes of the first and second cabinets are substantially on a plane.

### CROSS-REFERENCE TO RELATED APPLICATION

This application claims priority based on U.S. Patent Application No. 62/160,929 entitled “SURROUND SPEAKER” filed May 13, 2015, the subject matter of which is incorporated herein by reference in its entirety.

### FIELD OF THE INVENTION

The invention relates to loudspeakers, and in particular, a surround sound speaker system and a surround, speaker housing thereof.

### BACKGROUND

With added bandwidth both on streaming and physical media, such as Blu-ray, more and more program material contains 7.1 or more discreet channels of audio. To reproduce the soundtrack as complete as possible, more and more speakers are required in surround sound loudspeaker installations.

For example, a typical 7.1 surround sound setup includes 3 front speakers—left, centre, right, left and right surround speakers, left and right rear speakers and a subwoofer.

This requires viewer chairs to be away from the rear wall. Some installations, however, put limitations on the number of speakers and their placement in a room. In some rooms, listeners are sitting at the back of the room. This leaves no space for rear surround speaker installation.

As well, once a surround sound loudspeaker system is wired in one mode, such as a bipolar mode, it is generally fixed. To change to a different mode requires to re-wire the loudspeaker system, such as to a 2 channels mode.

### SUMMARY OF THE INVENTION

The present invention discloses a surround sound loudspeaker system that may be mounted on-wall or in the corner between the walls, and that may be switchable between first mode and a second mode.

The present invention also discloses a surround sound loudspeaker housing that allows the surround sound loudspeaker system be mounted on-wall or in the corner between the walls.

According to an embodiment of the present invention, there is provided a surround sound loudspeaker system, comprising;

a first speaker;

a second speaker; and

wherein the first speaker and the second speaker are switchable between a first mode and a second mode.

According to a further embodiment of the present invention, there is provided a surround sound loudspeaker system housing, comprising:

a first cabinet on a first side of the enclosure, the first cabinet comprising:
a front panel;
a side panel; and
a rear panel;

a second cabinet on a second side of the enclosure, the second cabinet comprising:
a front panel;
a side panel; and
a rear panel;

wherein first cabinet is acoustically isolated from the second cabinet the side plane of the second cabinet is in an angled position with the side plane of the first cabinet.

### BRIEF DESCRIPTION OF THE DRAWINGS

FIG. 1 is a top view of a housing for a surround sound loudspeaker system according to an embodiment of the present application.

FIG. 2A is a perspective view of a surround sound loudspeaker system according to an embodiment of the present application, illustrating that the system may be mounted on wall.

FIG. 2B is a perspective view of a surround sound loudspeaker system according to an embodiment of the present application, showing that the system may be mounted in the corner between walls.

FIG. 3 shows binging posts connections of a surround sound loudspeaker system in a bi-polar mode according to an embodiment of the present application.

### DETAILED DESCRIPTION OF EMBODIMENTS

Particular embodiments of the present invention will now be described with reference to the drawings. It will be understood by the skilled reader, however, that various modifications to the embodiments described herein are possible. Such modifications are intended to fall within the scope of the present invention, which is described by the claims.

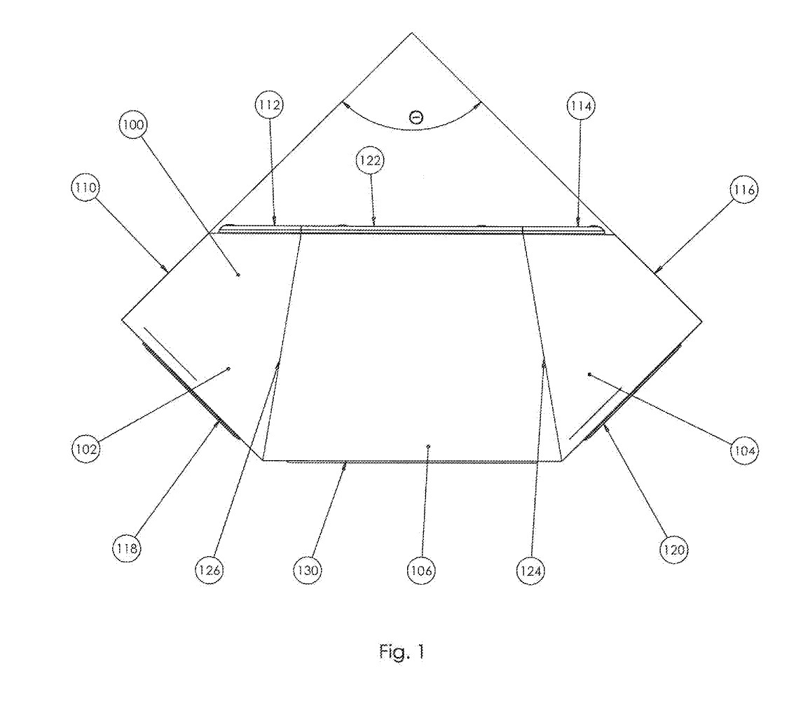

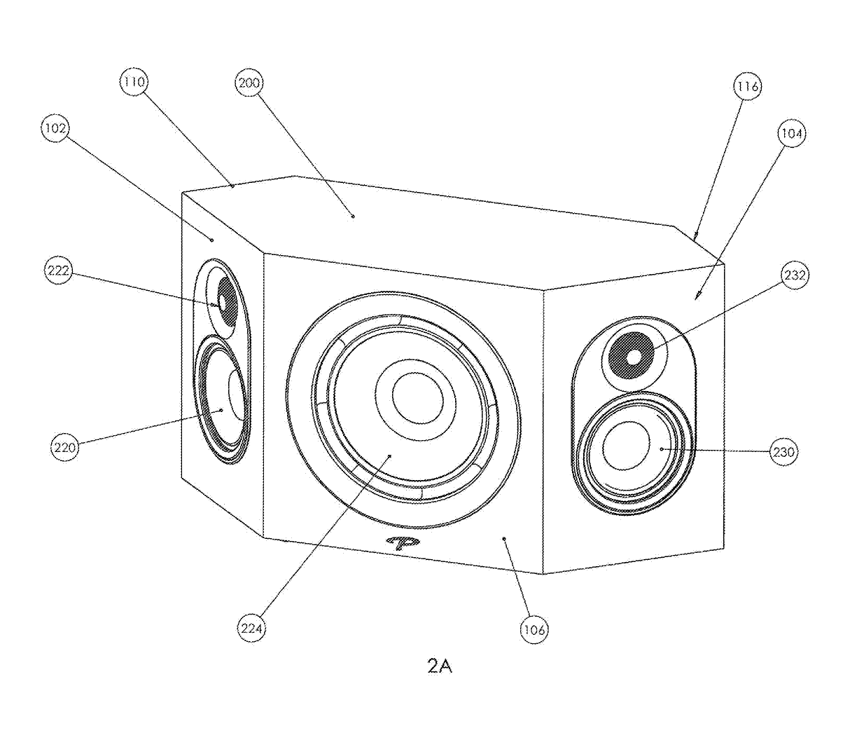

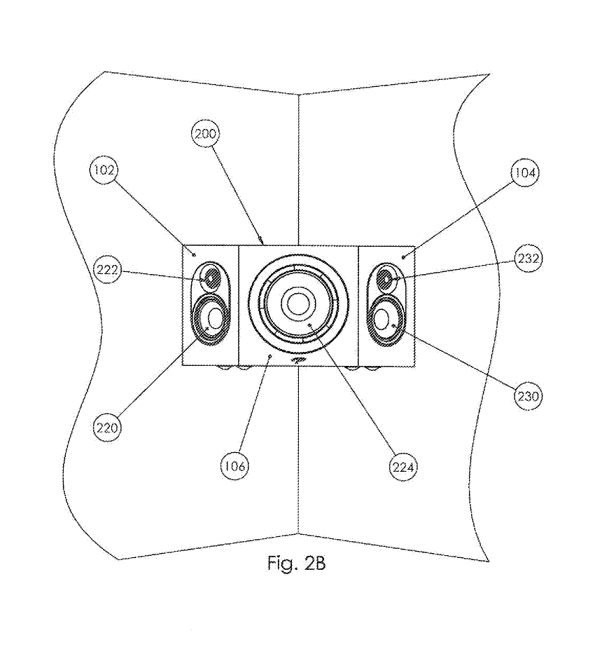

FIG. 1 shows a top view of a housing 100 of a surround sound loudspeaker system. The housing 100 comprises at least two cabinets 102 and 104 to receive loudspeakers. The first cabinet 102 has a rear panel 112, a side panel 110, and a front panel 118. The second cabinet 104 has a rear panel 114, a side panel 116, and a front panel 120. The side plane 110 of the first cabinet and the side plane 116 of the second cabinet are arranged to form an angle theta (θ) Each of the first cabinet 102 and the second cabinet 104 has a top panel 208 and a bottom panel 206 (in FIGS. 2a and 2b) to form an enclosure to receive at least one loudspeaker. The first cabinet 102 is acoustically isolated from the second cabinet 104, for example by a panel between the first cabinet 102 and the second cabinet 104, and/or by other acoustic isolation materials. The rear panels 112 and 114 of the first and the second cabinets are substantially on a plane.

The angle theta between the side panels 110 and 116 may be varied. Generally, theta may be a degree that can fit into the corner of two walls. Theta may be in a range of 80-120 degrees. In the examples of FIGS. 1, 2a and 2b, theta is about 90 degrees.

The housing 100 may also comprise a third cabinet 106 to receive at least one loudspeaker between the first cabinet 102 and the second cabinet 104. In this case, the third cabinet 106 is also acoustically isolated from the first and the second cabinets 102 and 104. The third cabinet 106 may comprise a rear panel 122, a front panel 130. To be acoustically isolated from the first and the second cabinets 102 and 104, the third cabinet 106 may have two side panels 124 and 126 that are shared with the first cabinet 102 and the second cabinet 104, respectively. Other acoustic isolation materials may also be used to acoustically isolate the third cabinet 106 from the first cabinet 102 and the second cabinet 104, In the case the third cabinet is used, the rear planes 112, 114 and 122 of the cabinets are substantially on a plane.

FIG. 2a and FIG. 2b illustrate a surround sound loudspeaker system 200 installed within the surround sound loudspeaker housing 100. FIG. 2a shows that the surround sound loudspeaker system 200 may be mounted on a wall. FIG. 2b demonstrates that the surround sound loudspeaker system 200 may be mounted in the corner formed between walls.

In FIGS. 2a and 2b, each of the first and second cabinets 102 and 104 comprises a high frequency loudspeaker 222 and a midrange frequency loudspeaker 220. FIGS. 2a and 2b also comprises a low frequency loudspeaker 224 in the third cabinet 106. Each of the first, second and third cabinets 102, 104, and 106 may also comprise a high frequency speaker, and/or a midrange frequency speaker, and/or a low frequency loudspeaker 224.

Each of the first and the second cabinets 102 and 104 may comprise at least one loudspeaker that can reproduce sound waves within a desired frequency range, such as sound waves in low, midrange and/or high frequency. In the examples of FIGS. 2a and 2b, each of the first and the second cabinet 102 and 104 comprises a high frequency loudspeaker and a midrange frequency loudspeaker. The high frequency loudspeakers 222 and 232 in the first and second cabinets 102 and 104 reproduce high frequency sound waves, and the midrange frequency loudspeakers 220 and 230 reproduce midrange frequency sound waves. The combination of the high frequency loudspeakers 222 and the midrange frequency loudspeaker 220 covers from midrange frequencies and up, for example, frequencies range from 200 Hz to 20 KHz.

A low frequency loudspeaker 224 may be separately used in the system 200 in the third cabinet 106 of the housing 100 to produce sound waves with frequencies below the midrange frequencies, for example, to produces frequencies below 200 Hz.

Each of the first and the second cabinets 102 and 104 may comprise a high frequency loudspeaker, a midrange frequency loudspeaker, a low frequency speaker, or a combination thereof. If a low frequency loudspeaker is used in the first and the second cabinets, the low frequency loudspeaker has a single voice coil. The low frequency loudspeaker 224 in the third cabinet 106, along with the third cabinet 106, may be omitted if the loudspeakers in the first and the second cabinets 102 and 104 already sufficiently produce the desired low frequency ranges.

The surround sound loudspeaker system 200 may be mounted on a wall. In the example of FIG. 2a, the loudspeakers 222 and 220 in the first cabinet 102 and the loudspeakers 232 and 230 in the second cabinet 104. If the system 200 is mounted on a side wall, the sound waves are radiated substantially both toward the front and rear directions of the room and toward the opposite wall. If mounted on the rear wall, the loudspeakers 222 and 220 in the first cabinet 102 and loudspeakers 232 and 230 in the second cabinets 104 radiate sound waves in both directions along the rear wall and towards the front.

If the surround sound loudspeaker system 200 mounted on walls also comprises a low frequency loudspeaker 224 in the third cabinet 106 of the housing 100, the low frequency loudspeaker 224 reproduces low frequency sound waves toward the opposite walls, for example, toward the opposite side wall if the system 200 is mounted on a side wall, and toward the front wall if mounted on a rear wall.

The surround sound loudspeaker system 200 may also be mounted in the corner between walls, for example, between a side wall and a rear wall. If the loudspeakers 222 and 220 in the first cabinet 102 is toward front direction, they radiate sound waves substantially along the side wall towards the front; and if loudspeakers 232 and 230 in the second cabinets 104 is adjacent to the rear wall and toward the opposite wall, they radiate sound waves substantially along the rear wall toward the opposite wall.

If the surround sound loudspeaker system 200 mounted in the corner between walls also comprises a low frequency loudspeaker 224 in the third cabinet 106 of the housing 100, the low frequency loudspeaker 224 reproduces low frequency sound waves toward the direction the low frequency loudspeaker is facing.

In the example of FIGS. 2a and 2b, the loudspeakers 222 and 220 in the first cabinet 102 and the loudspeakers 232 and 230 in the second cabinet 104 may be configured in bi-polar, di-polar, or 2 channel mode.

In bipolar mode, the loudspeakers 222 and 220 in the first cabinet 102 and the loudspeakers 232 and 230 in the second cabinet 104 can be wired to radiate “in phase” sound waves from both cabinets. In bipolar mode, the loudspeakers 222 and 220 in the first cabinet 102 and the loudspeakers 232 and 230 in the second cabinet 104 radiate sound waves simultaneously and both push and pull the sound waves at the same time. The loudspeakers 222 and 220 in the first cabinet 102 and the loudspeakers 232 and 230 in the second cabinet 104 in this mode create a diffuse surround effect and thus the sound location cannot be clearly identified. Because the sound waves are radiated “in phase” in bi-polar mode, he loudspeakers 222 and 220 in the first cabinet 102 and the loudspeakers 232 and 230 in the second cabinet 104 effectively create a single channel that radiates sound waves toward multiple directions. As such, the loudspeakers in the first and the second cabinets 102 and 104 create a wide dispersion pattern. In bi-polar mode, the surround sound loudspeaker system 200 can be used as conventional surround or rear speaker either mounted on the wall or in the corner.

In bi-polar mode, the surround sound loudspeaker system 200 may comprise a low frequency loudspeaker 224 in the third cabinet 106 of housing 100 to radiate sound waves in low frequency range and functions as low frequency differentiation. The low frequency loudspeaker 224 in the third cabinet 106 in this case comprises a dual voice coil. The low frequency loudspeaker 224 in bi-polar mode does not contribute to localization.

In di-polar mode, the loudspeakers 222 and 220 in the first cabinet 102 and the loudspeakers 232 and 230 in the second cabinet 104 can be wired to radiate “out of phase” sound waves. In this mode, the sound waves radiated from the loudspeakers 222 and 220, including a low frequency loudspeaker, in the first cabinet 102 is electrically out of phase from those radiated from the loudspeakers 232 and 230 in the second cabinet 104. Di-polar mode can also create a diffuse and enveloping surround sound effect.

In di-polar mode, the low frequency loudspeaker 224 in the third cabinet 106 can be omitted.

In 2 channel mode, the loudspeakers 222 and 220 in the first cabinet 102 and the loudspeakers 232 and 230 in the second cabinet 104 can be wired substantially reproduce rear speaker sound waves from one cabinet, such as the first cabinet 102, and surround speaker sound waves using the other cabinet, such as the second cabinet 104. The surround sound loudspeaker systems 200 may be mounted to the left and right of the listener position either on side walls or in the corners between the walls.

In 2 channel mode, the surround sound loudspeaker system 200 may comprise a low frequency loudspeaker 224 to mix sound waves produced in both cabinets 102 and 104 as low frequency differentiation. The low frequency loudspeaker 224 in the third cabinet 106 in this case contains a dual voice coil. The low frequency loudspeaker 224 does not contribute to localization.

If the surround sound loudspeaker system 200 comprises a low frequency loudspeaker 224 in the third cabinet 106 for use in the 2 channel mode or bipolar mode, the low frequency loudspeaker 224 may have a dual voice coil. The dual voice coil has 2 coils, and each coil has a positive and a negative terminal.

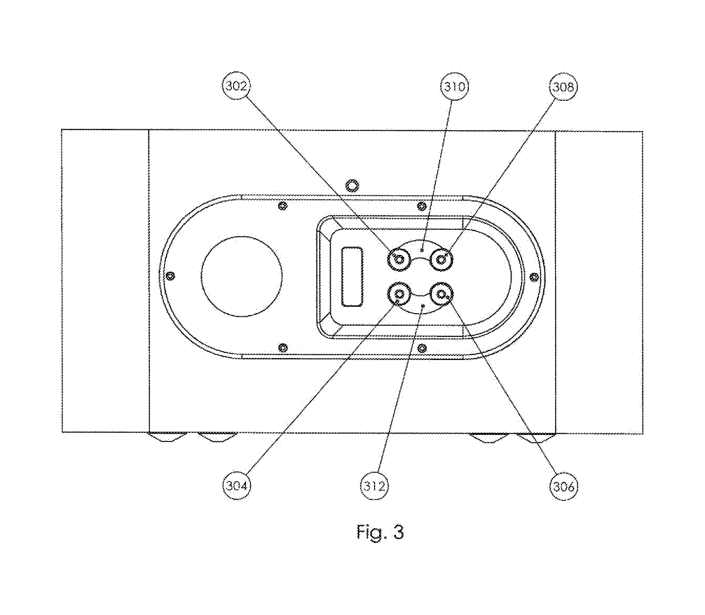

FIG. 3 shows two pairs of binding posts 302, 304, 306 and 308 that may be used with the surround sound loudspeaker system 200. The loudspeakers 220 and 222 in the first cabinet 102, and 232 and 230 in the second cabinet may connected the binding posts via crossover filters. Each pair of the binding posts has a negative terminal and a positive terminal, for example, in the pair of the binding posts 302 and 304, 302 may be a positive terminal and 304 may be a negative terminal. A loudspeaker of one cabinet may be connected to a pair of binding posts. For example, the binding posts 302 and 304 may be connected to at least one loudspeaker. For example, the binding posts 302 and 304 may be connected to the high, midrange and/or low frequency loudspeakers in the first cabinet 102 in the examples of FIGS. 2a and 2b; the right binding posts 306 and 308 may be similarly connected to the high, midrange and/or low frequency loudspeakers in the second cabinet 104.

If a low frequency loudspeaker 224 with a dual voice coil is used in the 2 channel mode or bi-polar mode, the left binding posts 302 and 304 may be connect to the two terminals of the first voice coil of the low frequency loudspeaker 224, and the right binding posts 306 and 308 may be connected to the two terminals of the second voice coil of low frequency loudspeaker 224.

The mode of the surround sound loudspeaker system 200 may be inter-switched. FIG. 3 shows an example of bi-polar mode connection of the loudspeakers of the system 200. In the example of FIG. 3, the two positive terminals of the two pair binding posts are connected with a jumper bar 310, and the two negative terminals of the two pair binding posts are connected with a jumper bars 312. The bi-polar, di-polar and 2 channel modes of the high, midrange, and/or low frequency loudspeakers in cabinets 102 and 104 of surround sound loudspeaker system 200 may be inter-switched by varying the connections of the binding posts. For example, the bi-polar mode in FIG. 3 may be switched to 2 channels mode by simply removing jumper bars connecting left and right binding posts, or vice versa. The 2 channels mode can be switched to a di-polar mode by connecting with a first jumper bar the positive terminal 302 of the first pair of the binding posts to the negative terminal 306 of the second part of the binding posts; and connecting by a second jumper bar the negative terminal 304 of the first pair of the binding posts with the positive terminal 308 of the second pair of the binding posts. The di-polar mode can be switched to a bi-polar mode by connecting the terminals of the posts as shown in FIG. 3.

If a separate low frequency transducer 224 with a dual voice coil is used in the third cabinet 106, the mode of the surround sound loudspeaker system 200 may be inter-switched between bi-polar mode and 2 channel mode.

The cabinets 102, 104, and 106 are acoustically isolated from each other. Loudspeakers in a cabinet, such 220 and 224, are also acoustically isolated. For example, the SHOCK-MOUNT™ Isolation Mounting system may be used to reduce unwanted cabinet resonances that interfere with the sound waves.

The surround sound loudspeaker housing 100 may use acoustically inert high-density or medium density hardboard and radial braces to minimize unwanted resonances. Acoustic damping materials may be used in the cabinets 102, 104, and 106 to eliminate internal standing sound waves.

The dimension of the cabinet for each loudspeaker in the surround sound loudspeaker housing 100 depends on the dimensions of each individual loudspeaker. The dimensions of each individual loudspeaker depend from the required frequency range and output power level.

The scope of the claims should not be limited by the embodiments set forth in the examples, but should be given the broadest interpretation consistent with the specification as a whole.

We claim:

1. A surround sound loudspeaker system, comprising:
a first speaker;
a second speaker; and
wherein the first speaker and the second speaker are switchable between a first mode and a second mode.

2. The surround sound loudspeaker system of claim 1, further comprising a housing, the housing comprising:
a first cabinet receiving the first speaker; and
a second cabinet receiving the second speaker,
wherein the first cabinet is acoustically isolated from the second cabinet.

3. The surround sound loudspeaker system of claim 1, further comprising a third speaker placed in a third cabinet between the first and the second cabinets,

4. The surround sound loudspeaker system of claim 1, wherein the first mode comprises any one of a 2 channels mode, a di-polar mode, and a bipolar mode.

5. The surround sound loudspeaker system of claim 1, wherein the second mode comprises any one of a 2 channels mode, a di-polar mode, and a bi-polar mode, and wherein the second mode is different from the first mode.

6. The surround sound loudspeaker system of claim 1, wherein the first and second modes comprise a 2 channels mode and a bi-polar mode, respectively.

7. The surround sound loudspeaker system of claim 3, wherein the third speaker is a low frequency speaker.

8. The surround sound loudspeaker system of claim 7, wherein the low frequency speaker contains a dual voice coil.

9. The surround sound loudspeaker system of claim 1, wherein the first and the second speakers comprise a high frequency speaker, a midrange frequency speaker, a low frequency speaker or a combination thereof.

10. A surround sound speaker system housing, comprising:
a first cabinet on a first side of the housing;
a second cabinet on a second side of the housing;
each of the first cabinet and the second cabinet comprising:
a front panel;
a side panel; and
a rear panel;
wherein the first cabinet is acoustically isolated from the second cabinet, and wherein the side panel of the second cabinet is in an angled position with respect to the side panel of the first cabinet.

11. The surround sound speaker system housing of claim 10, further comprising a third cabinet between the first and the second cabinets.

12. The surround sound speaker system of claim 11, further comprising first, second, and third speakers placed in the first, the second, and the third cabinets, respectively.

13. The surround sound speaker system of claim 10, further comprising first and second speakers placed in the first and the second cabinets, respectively.
